(19) United States
(12) Patent Application Publication
(10) Pub. No.: US 2010/0061339 A1
(43) Pub. Date: Mar. 11, 2010

(54) HANDOVER METHOD WITH MOBILE RELAY STATION

(76) Inventors: Sung-Kyung Kim, Seoul (KR); Sung-Cheol Chang, Daejeon-city (KR); Chul-Sik Yoon, Seoul (KR)

Correspondence Address: STAAS & HALSEY LLP, SUITE 700, 1201 NEW YORK AVENUE, N.W., WASHINGTON, DC, 20005, US

(21) Appl. No.: 12/514,973

(22) PCT Filed: May 7, 2007
(86) PCT No.: PCT/KR07/02241

§ 371 Date: May 14, 2009

(30) Foreign Application Priority Data
Nov. 14, 2006 (KR) 10-2006-0772454
May 7, 2007 (KR) 10-2007-0043938

(51) Int. Cl. H04W 4/00

(52) U.S. Cl. 370/331

(57) ABSTRACT

There is provided a handover method by a mobile relay station (MRS) or base station (BS) so as to effectively perform a handover of the MRS and mobile stations (MSs) in an environment in which data is communicated through a relay of the MRS. There is also provided a handover method capable of securing backward compatibility of an MS during a handover. There is provided a handover method in which an MRS is considered. It is possible to improve the efficiency of the handover by allowing handovers of the MRS and MSs to which the MRS relays to be initiated by the MRS or BS. It is possible to secure the backward compatibility of the MSs by allowing the MRS to generate and manage a mapping relation between information on communication identifiers (CIDs) of the MSs, which are changed during the handover, and information on previous CIDs of the MSs.

### TECHNICAL FIELD

The present invention relates to a handover method, and more particularly, to a handover method with a mobile relay station (MRS) in a wireless system.

### BACKGROUND ART

FIG. 1 illustrates an example of a mobile relay station (MRS) suggested in IEEE 802.16j.

An MRS 110, which is mounted on a mobile means such as a bus, train, or cruise, provides one or more multi-paths in order to provide a high speed wireless internet service to passengers. To provide a service to a mobile station (MS) 120 without breaking the connection in a broadband mobile internet system, a handover (HO) function between the MS 120 and a base station (BS) 100 has be considered. In order to support the handover function, hard HO (HHO) (FIG. 2a), fast base station switching (FBSS) (FIG. 2b), and macro diversity handover (MDHO) (FIG. 2c) techniques are suggested in IEEE 802.16e

In general, a radio link between the BS 100 and the MRS 110 has a higher quality than a radio link between the BS 100 and the MS 120. The MRS 110 uses a directionality and multi-antenna technique or high quality radio transmission technique. Accordingly, the MRS 110 can provide a high quality wireless environment to the MS 120. In addition, when the BS 100 needs to be changed due to the quality deterioration of the radio link, the MRS 110 more easily determines a handover time than the MS 120.

FIGS. 2a to 2c illustrate the connection relations among an MRS and MSs according to a conventional HO method suggested in IEEE 802.16e.

FIG. 2a illustrates the HHO technique suggested in IEEE 802.16e. FIG. 2b illustrates the FBSS HO technique. FIG. 2c illustrates the MDHO technique. In case of the HHO technique, MSs and BSs can request the handover. Specifically, there are two cases including a case where the MSs can directly communicate with the BSs without passing the MRS (refer to FIG. 3) and a case where the MSs can communicate the BSs via the MRS (refer to FIG. 4).

As shown in FIG. 2c, during the MDHO operation in which the MRS receives a service from two BSs in an active BS set, the MSs which receive the service through the MRS operate as though they receive the service from one BS without the MDHO. At this time, the MRS can use radio resources of the existing BS within a range in which the MRS does not interfere with a neighbor BS. Like the MDHO, the FBSS handover shown in FIG. 2b is limited to radio links between the BSs and the MRS. Even when an anchor BS between the MRS and the MSs is changed, the MSs operate as though the MSs communicate with the BS without the anchor change.

FIG. 3 illustrates an HO procedure in a case where MSs can directly communicate with BSs among HO methods suggested in IEEE 802.16e.

Referring to FIG. 3, the MRS performs a handover 300, and then, the MSs attempt to perform a handover 310 with the BS at nearly the same time, upon sensing a weak signal.

Specifically, the MS starts the handover by transmitting a message MOB_MSHO_REQ directly to the BS. The message MOB_MSHO_REQ includes factors (for example, a carrier to interference-plus-noise ratio (CINR), a received signal strength indicator (RSSI), and a relative delay of the BS) which cause the handover, information on one or more target BSs, and the like. Since the message

MOB_MSHO_REQ is defined in IEEE 802.16e, the description on the message is omitted. The following messages are defined in IEEE 802.16e unless otherwise stated. When an existing message is modified, the modified part will be described.

The BS transmits a message MOB_BSHO_RSP to the MS as a response. The message MOB_BSHO_RSP may include identification information BS_ID of a neighbor BS to which the MS belongs, a service prediction level of the neighbor BS, an action time, and the like. A service prediction level field is used to represent to which degree a target mobile multi-hop relay BS (target MMR-BS) secures a service of the MS which is being executed in a serving BS. An action time field is used to represent the number of frames used until receiving dedicated radio resources through which the MS can transmit a message RNG-REQ to the target BS. The MS terminates the connection with the serving BS by determining the target MS which is to perform a practical handover (HO) and by transmitting a message MOB_HO_IND to the BS. At this time, the message MOB_HO_IND includes HO_IND_type and target BSID.

FIG. 4 illustrates an HO procedure in a case where MSs cannot directly communicate with BSs among HO methods suggested in IEEE 802.16e.

Referring to FIG. 4, after an MRS performs a handover, an MS senses a break of communication, searches for a new cell, and performs a procedure of newly entering a network. Since a probability that a plurality of MSs attempt to enter the network at the same time is high, congestion occurs in a random access channel. Accordingly, it takes a long time to enter the network. This causes a long-time break of communication. Therefore, it is difficult to continuously provide a service.

### DESCRIPTION OF DRAWINGS

FIG. 1 illustrates an example of a mobile relay station (MRS) suggested in IEEE 802.16j.

FIGS. 2a to 2c illustrate connection relations among an MRS and MSs according to a conventional handover method suggested in IEEE 802.16e.

FIG. 3 illustrates a handover procedure in a case where MSs can directly communicate with base stations (BSs) among handover methods suggested in IEEE 802.16e.

FIG. 4 illustrates a handover (HO) procedure in a case where MSs cannot directly communicate with BSs among handover methods suggested in IEEE 802.16e.

FIGS. 5 and 6 illustrate an HO procedure initiated by an MRS according to an embodiment of the present invention.

FIGS. 7 and 8 illustrate an HO procedure initiated by a BS according to an embodiment of the present invention.

FIG. 9 illustrates an HO procedure by considering backward compatibility of mobile stations (MSs) according to an embodiment of the present invention.

FIG. 10 illustrates an HO procedure by not considering backward compatibility of MSs according to an embodiment of the present invention.

FIG. 11 illustrates a format of a group handover request message G_RSHO_REQ according to an embodiment of the present invention.

FIG. 12 illustrates a format of a group handover response message G_BSHO_RSP according to an embodiment of the present invention.

FIG. 13 illustrates a format of a group handover execution message G_HO_IND according to an embodiment of the present invention.

FIG. 14 illustrates a format of a group handover request message G_BSHO_REQ according to an embodiment of the present invention.

FIG. 15 illustrates a type/length/value (TLV) to be newly included in a message RNG_REQ according to an embodiment of the present invention.

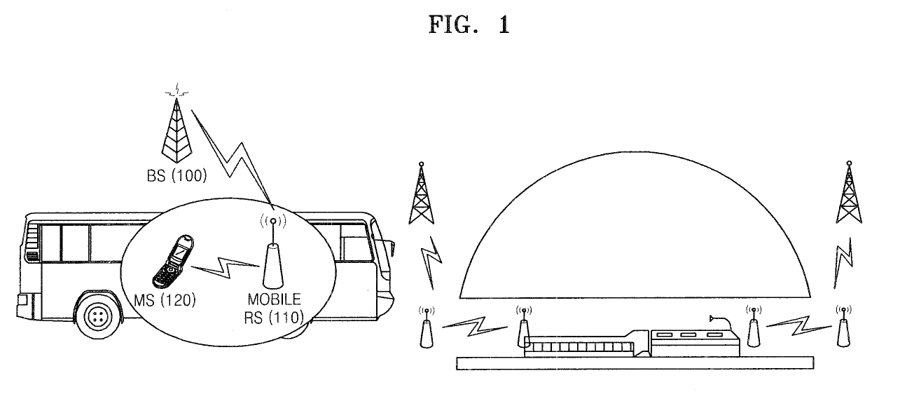

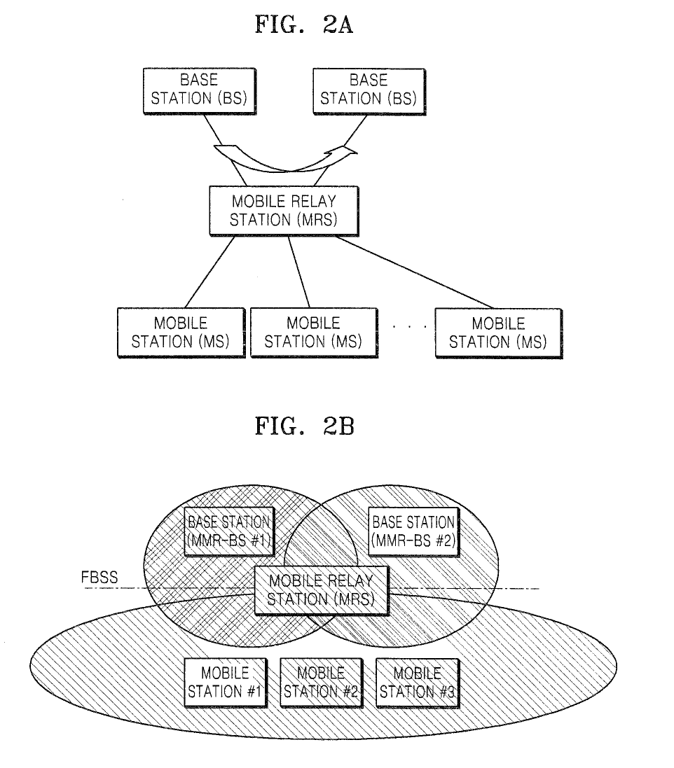

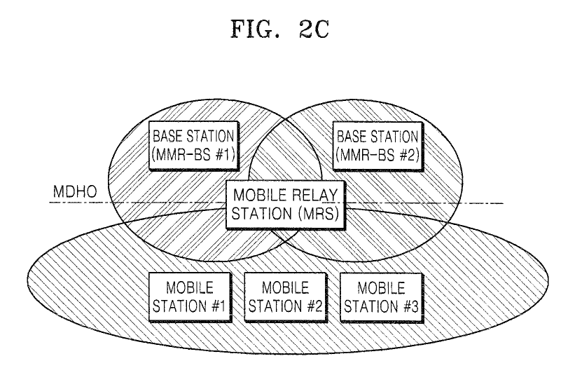

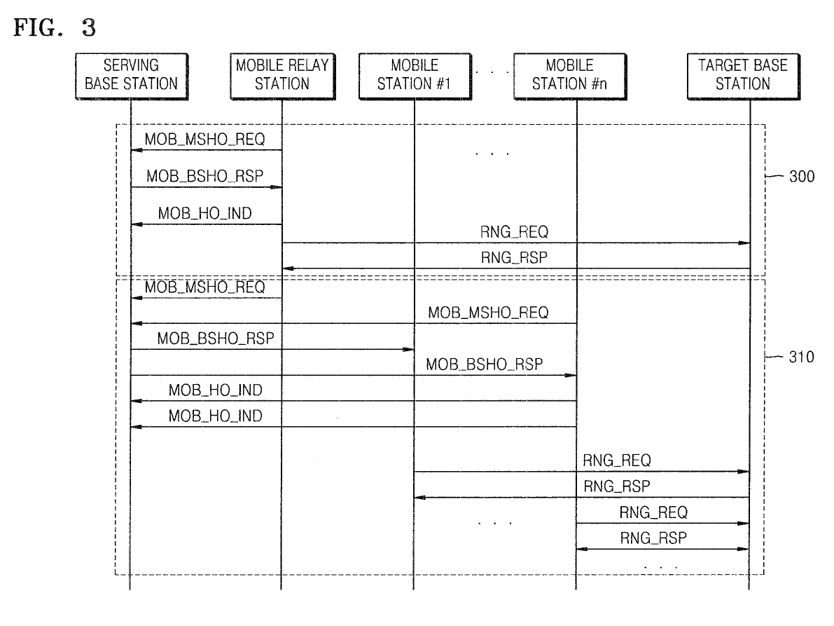

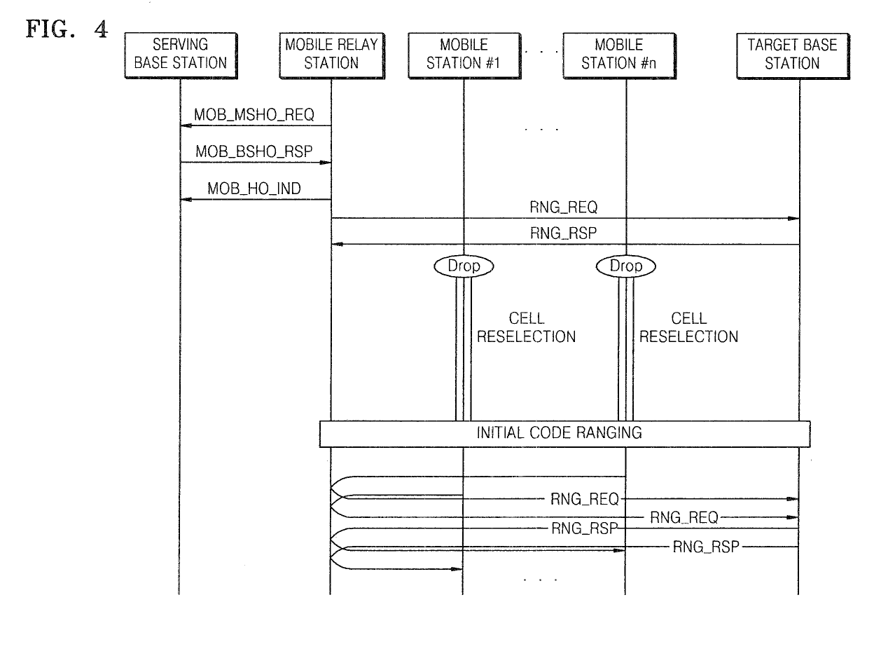

### DISCLOSURE

### Technical Problem

The present invention provides a handover method by a mobile relay station (MRS) or base station (BS) in order to effectively perform a handover of the MRS and mobile stations (MSs) in an environment in which data is communicated through a relay of the MRS.

The present invention also provides a handover method capable of securing backward compatibility of an MS during a handover.

### Technical Solution

According to an aspect of the present invention, there is provided a handover method for a Mobile Relay Station (MRS), the handover method including transmitting a handover request message to a serving Base Station (BS), wherein the handover request message includes an Identifier (ID) of the Mobile Relay Station; and receiving a handover response message from the serving Base Station, wherein the handover response message indicates that the serving Base Station recognizes handover requests of the Mobile Relay Station and the Mobile Stations which are attached to the is Mobile Relay Station.

According to another aspect of the present invention, there is provided a handover method for a Base Station (BS), the handover method including receiving a handover request message; determining whether the handover request message is from a Mobile Relay Station (MRS) based on an Identifier (ID) included in the handover request message; and transmitting a handover response message to the Mobile Relay Station, wherein the handover response message indicates that handover requests of the Mobile Relay Station and the Mobile Stations which are attached to the Mobile Relay Station are recognized.

According to another aspect of the present invention, there is provided a handover method in a Base Station (BS), the handover method including transmitting a handover request message to an Mobile Relay Station (MRS); and receiving a handover execution message from the Mobile Relay Station, wherein the handover execution message includes information on a target Base Station.

According to another aspect of the present invention, there is provided a handover method for a Mobile Relay Station (MRS), the handover method including transmitting a handover request message to a Base Station (BS), wherein the handover request message includes an Identifier (ID) of the Mobile Relay Station; receiving a handover response message from the Base Station, wherein the handover response message indicates that the Base Station recognizes a handover request of the Mobile Relay Station; transmitting a handover execution message to the Base Station, wherein the handover execution message includes information on a target Base Station; transmitting a ranging request message to the target Base Station; receiving a ranging response message from the target Base Station, wherein the ranging response message includes first Identifiers that are newly assigned to the Mobile Stations which are attached to the Mobile Relay Station; and generating a mapping relation between second IDs that are previously assigned to the Mobile Stations and the first IDs that are newly assigned to the Mobile Stations.

### Advantageous Effects

According to an embodiment of the present invention, since handovers of a mobile relay station (MRS) and mobile stations (MSs) which are attached to the MRS are initiated by the MRS or base stations (BSs), it is possible to reduce breaks of communication to effectively use radio resources.

### Best Mode

According to an aspect of the present invention, there is provided a handover method for a Mobile Relay Station (MRS), the handover method including transmitting a handover request message to a serving Base Station (BS), wherein the handover request message includes an Identifier (ID) of the Mobile Relay Station; and receiving a handover response message from the serving Base Station, wherein the handover response message indicates that the serving Base Station recognizes handover requests of the Mobile Relay Station and the Mobile Stations which are attached to the Mobile Relay Station.

According to another aspect of the present invention, there is provided a handover method for a Base Station (BS), the handover method including receiving a handover request message; determining whether the handover request message is from a Mobile Relay Station (MRS) based on an Identifier (ID) included in the handover request message; and transmitting a handover response message to the Mobile Relay Station, wherein the handover response message indicates that handover requests of the Mobile Relay Station and the Mobile Stations which are attached to the Mobile Relay Station are recognized.

According to another aspect of the present invention, there is provided a handover method in a Base Station (BS), the handover method including transmitting a handover request message to an Mobile Relay Station (MRS); and receiving a handover execution message from the Mobile Relay Station, wherein the handover execution message includes information on a target Base Station.

According to another aspect of the present invention, there is provided a handover method for a Mobile Relay Station (MRS), the handover method including transmitting a handover request message to a Base Station (BS), wherein the handover request message includes an Identifier (ID) of the Mobile Relay Station; receiving a handover response message from the Base Station, wherein the handover response message indicates that the Base Station recognizes a handover request of the Mobile Relay Station; transmitting a handover execution message to the Base Station, wherein the handover execution message includes information on a target Base Station; transmitting a ranging request message to the target Base Station; receiving a ranging response message from the target Base Station, wherein the ranging response message includes first Identifiers that are newly assigned to the Mobile Stations which are attached to the Mobile Relay Station; and generating a mapping relation between second IDs that are previously assigned to the Mobile Stations and the first IDs that are newly assigned to the Mobile Stations.

### Mode for Invention

Hereinafter, a handover method with a mobile relay station (MRS) according to an embodiment of the present invention will be described more fully with reference to the accompanying drawings.

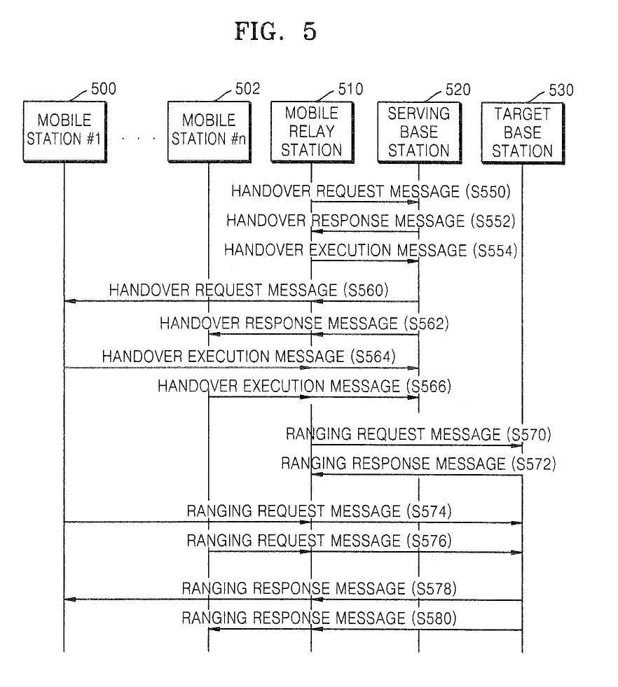

FIG. 5 illustrates a handover (HO) procedure initiated by an MRS according to an embodiment of the present invention.

Referring to FIG. 5, when a handover is necessary, an MRS 510 transmits a handover request message to a serving base station (serving BS) 520 (S550). The handover request message includes an identifier (ID) of the MRS 510. The ID of the MRS may include a basic communication identifier (basic CID) of a media access control (MAC) header. The MRS 510 uses an existing message MOB_MSHO_REQ defined in IEEE 802.16e or a newly defined message.

It is assumed that the ID of the MRS 510 and IDs (for example, CIDs of MAC headers) of mobile stations (MSs) 500 and 502 which are attached to the MRS 510 are previously known to the serving BS 520 through a backbone network.

When receiving a handover request message from the MRS 510 (S550), the serving BS 520 recognizes that the MRS 510 requests the handover based on the ID of the MRS included in the handover request message. In case of a handover request of the MRS 510, the serving BS 520 recognizes that the handover request includes a handover request of the MRS 510 and handover requests of the subordinate MSs 500 and 502 of the MRS 510. The serving BS 520 transmits a handover response message to the MRS 510 in response to the handover request message (S552). The serving BS 520 prepares an HO procedure of the MSs 500 and 502 requested by the MRS. The handover response message may be an existing message MOB_BSHO_RSP defined in IEEE 802.16e or newly defined message.

The serving BS 520 and a target BS 530 can set an action time field for fast handover ranging using a message MOB_BSHO_REQ/RSP defined in IEEE 802.16e.

When receiving the handover response message, the MRS 510 determines a target BS which is to perform the handover, transmits a handover execution message to the serving BS, and terminates the connection with the serving BS (S554). The handover execution message may be a message MOB_HO_IND defined in IEEE 802.16e or newly defined message.

The serving BS 520 transmits the handover request message (for example, the message MOB_BSHO_REQ) to the subordinate MSs 500 and 502 of the MRS 510 (S560 and S562). The serving BS sets an HO operation mode of the message MOB_BSHO_REQ to 1 and transmits the message. The serving BS 520 can set the action time field so as to assign a dedicated transmission opportunity for the message RNG REQ transmitted from the MS.

The MSs 500 and 502 transmit the handover execution messages (for example, the messages MOB_HO_IND) to the serving BS 520 via the MRS 510 (S564 and S566). The MRS 510 and the subordinate MSs 500 and 502 of the MRS 510 perform a ranging procedure (a procedure of transmitting a ranging request message (for example, the message RNG_REQ) (S570, S574, and S578) and receiving a ranging response message (for example, the message RNG_RSP) (S572, S576, and S580)) with the target BS 530. Here, the messages defined in IEEE 802.16e are used as examples of the messages used to perform the handover and the ranging procedure of the MSs. Messages having different formats may be defined and used for the same object. When the formats of the messages are changed due to a change of IEEE 802.16e, the changed messages may be used. In addition, when procedures defined in IEEE 802.16e are changed, the changed procedures may be applied. The aforementioned relation is the same in the following.

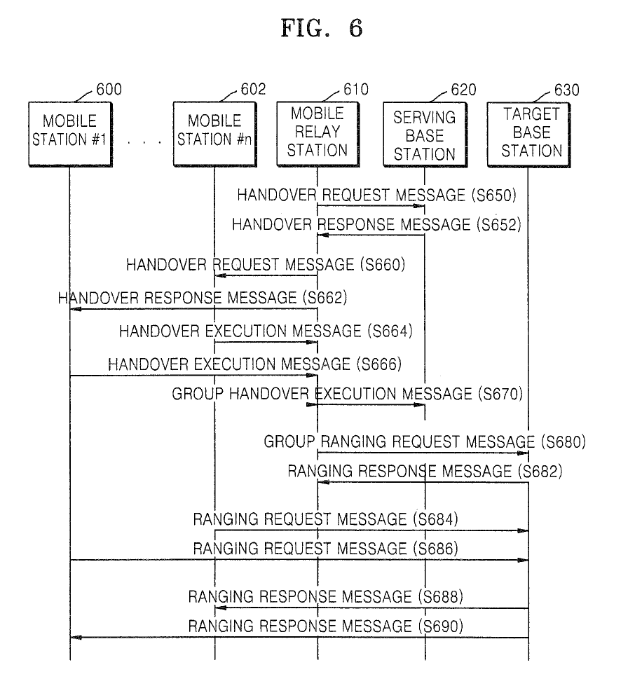

FIG. 6 illustrates a HO procedure initiated by an MRS according to another embodiment of the present invention.

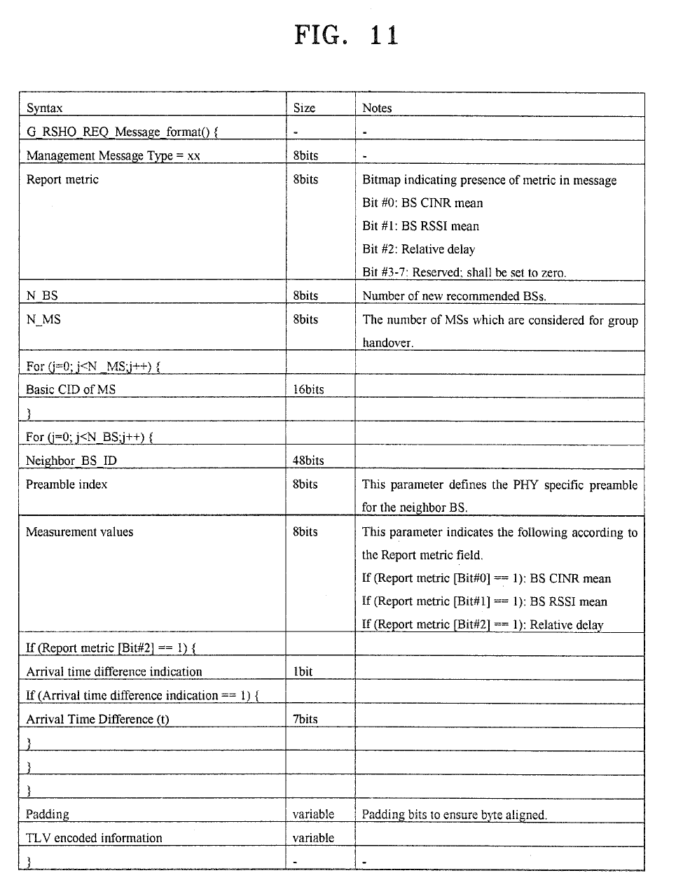

Referring to FIG. 6, an MRS 610 transmits a group handover request message to a serving BS 620 (S650). The group handover request message includes information needed for an HO procedure among information on the subordinate MSs 600 and 602 of the MRS 610 and information of the message MOB_MSHO_REQ defined in IEEE 802.16e. In the embodiment, a message G_RSHO_REQ (Group RS HO Request) is defined as the group handover request message. FIG. 11 illustrates a format of the message G_RSHO_REQ according to an embodiment of the present invention.

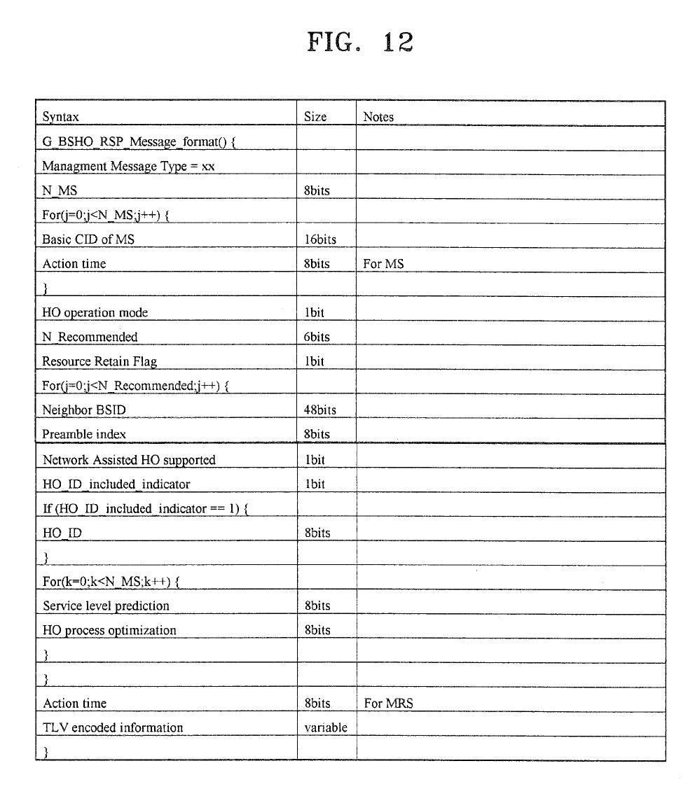

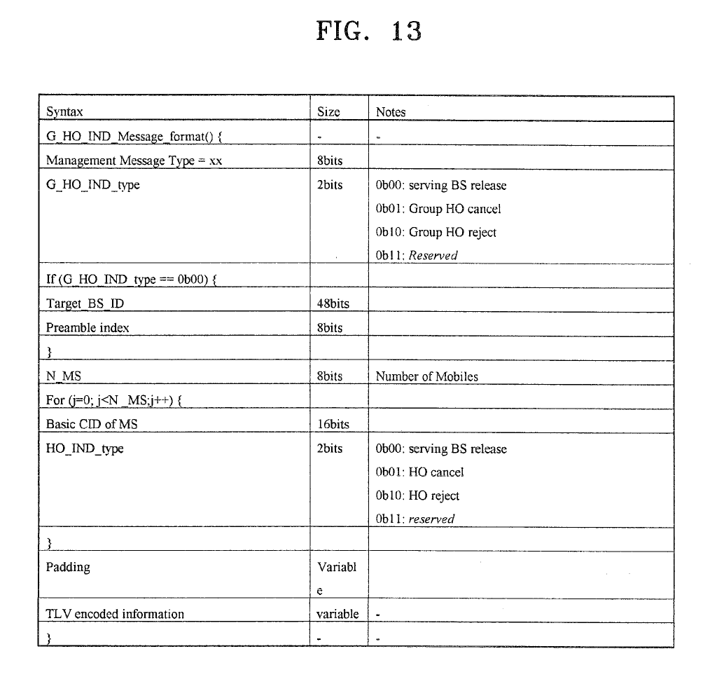

When receiving the group handover request message, the serving BS 620 recognizes the handover request of the MRS 610 and the MSs 600 and 602 included in the handover request message and transmits a group handover response message to the MRS 610 as a response to the group handover request message (S652). A message G_BSHO_RSP (Group BS HO Response) is defined as an example of the group handover response message. FIG. 12 illustrates a format of the message G_BSHO_RSP according to an embodiment of the present invention.

In order to provide a group HO while securing backward-compatibility (that is, the MSs are not changed) of the MSs as in IEEE 802.16e, the MSs 600 and 602 have to recognize the MRS 610 as the serving BS 620.

When receiving the group handover response message from the BS, the MRS 610 amplifies and relays a signal (for example, broadcasting information such as a preamble, a fundamental channel (FCH), a mobility anchor point (MAP), and the like) of the target BS so as to derive the HOs of the MSs. Alternatively, the MRS 610 stops the relay of signals of the serving BS or reduces transmission power. Then, the MRS performs the same HO with the MSs as defined IEEE 802.16e.

Specifically, the MRS 610 transmits a handover request message to the MSs 600 and 602 (S660 and S662). The MSs 600 and 602 determines a target BS and transmits a handover execution message to the MRS 610(S664 and S666). The handover request message transmitted from the MRS 610 to the MSs 600 and 602 may be the existing message MOB_BSHO_REQ defined in IEEE 802.16e or a newly defined message. In addition, the handover execution message from the MSs 600 and 602 to the MRS 610 may be the existing message MOB_HO_IND defined in IEEE 802.16e or a newly defined message.

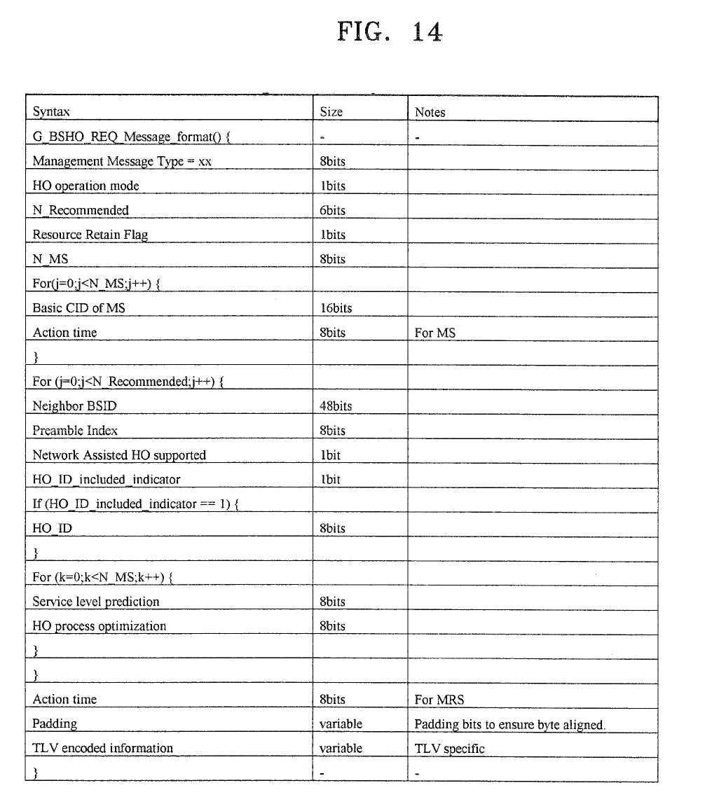

When receiving the handover execution message from all the MSs, the MRS 610 transmits the group handover execution message to the serving BS 620 (S670). The group handover execution message includes information on whether the MSs perform the practical handover and information on the MSs to be handovered. As an example of the group handover execution message, as shown in FIG. 13, a message G_HO_IND (Group HO Indication) is defined and used.

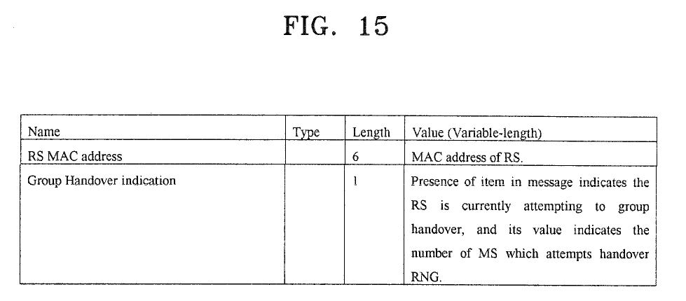

The MRS 610 terminates the connection with the serving BS 620 and performs a procedure of entering a network for the target BS 630. At this time, the MRS 610 transmits a group ranging request message including ranging requests of the MRS 610 and the subordinate MSs of the MRS 610 to the target BS 630 (S680). The group ranging request message may use the message RNG_REQ defined in IEEE 802.16e. For example, a Group HO indication field is added to the message RNG_REQ. When a value of the Group HO indication field is equal to or greater than 1, the value represents the group handover. The value of the Group HO indication field indicates the number of the handovered MSs. FIG. 15 illustrates a type/length/value (TLV) to be newly included in an existing message RNG_REQ so as to be used as a group ranging request message according to an embodiment of the present invention.

When dedicated radio resources are assigned at a time suggested by the action time field of the group handover response message, the MRS 610 can omit a random access procedure using HO codes and directly transmit the RNG-REQ message without a collision.

When receiving the group ranging request message from the MRS 610, the target BS 630 can know the number of MSs which attempt to newly enter a cell by recognizing the Group HO indication field in the message. Therefore, the target BS 630 can change an amount of radio resources required by a random access channel.

The target BS 630 transmits a ranging response message to the MRS 610 (S682). Then, the MSs 600 and 602 transmit and receive the ranging request/response message to and from the target BS 630 (S684 to S690).

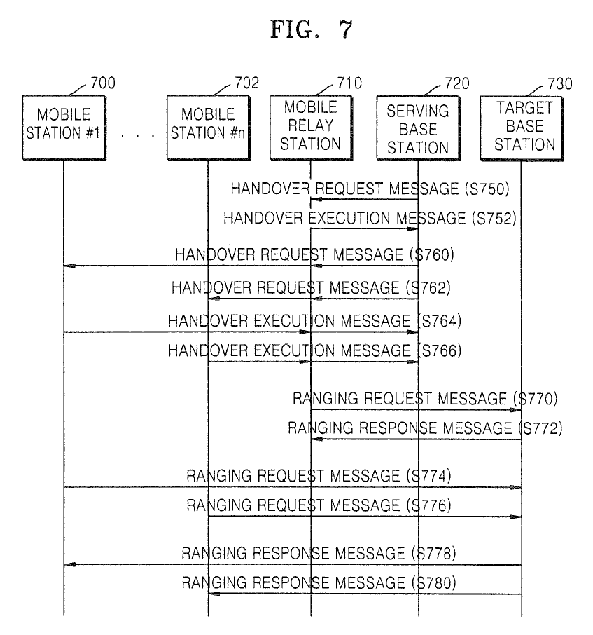

FIG. 7 illustrates a HO procedure initiated by a BS according to an embodiment of the present invention.

Referring to FIG. 7, when a handover of an MRS is necessary, a serving BS 720 transmits a handover request message to an MRS 710 (S750). The handover request message may be the existing message MOB_BSHO_REQ defined in IEEE 802.16e or a newly defined message. When receiving the handover request message, the MRS 710 transmits a handover execution message to the serving BS 720 (S752). The handover execution message may be the existing message MOB_HO_IND defined in IEEE 802.16e or a newly defined message.

In FIG. 7, as in FIG. 5, it is assumed that the serving BS 720 previously recognizes information on the MRS 710 and all the subordinate MSs 700 and 702 of the MRS 710. Since following procedures are the same as those described with reference to FIG. 5, the detailed description on the procedures will be omitted.

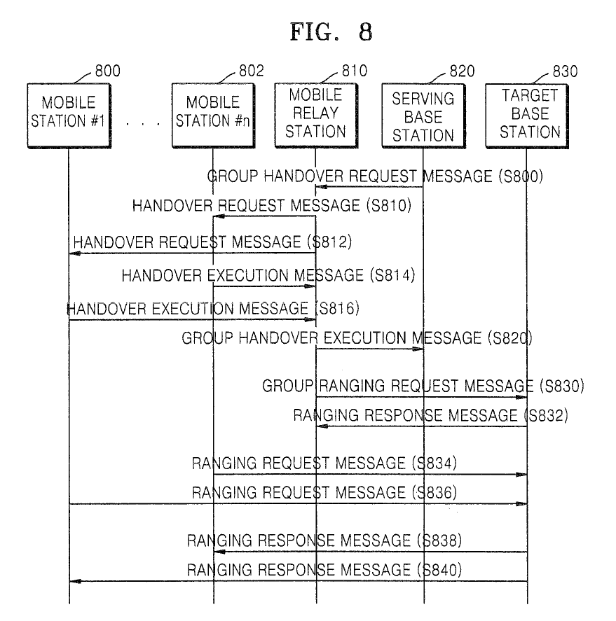

FIG. 8 illustrates an HO procedure initiated by a BS according to another embodiment of the present invention.

Referring to FIG. 8, when a handover of an MRS 810 is necessary, the serving BS 820 transmits a group handover request message to the MRS 810 (S800). The group handover request message includes information on MSs to be group-handovered and information on neighbor BSs. As an example of the group handover request message, as shown in FIG. 14, a message G_BSHO_REQ (Group HO Indication) is defined and used.

When receiving the handover request message from the serving BS 820, the MRS 810 performs an HO procedure that is the same as the procedure illustrated in FIG. 6. Since the HO procedure is performed as illustrated in FIG. 6, the detailed description on the HO procedure will be omitted.

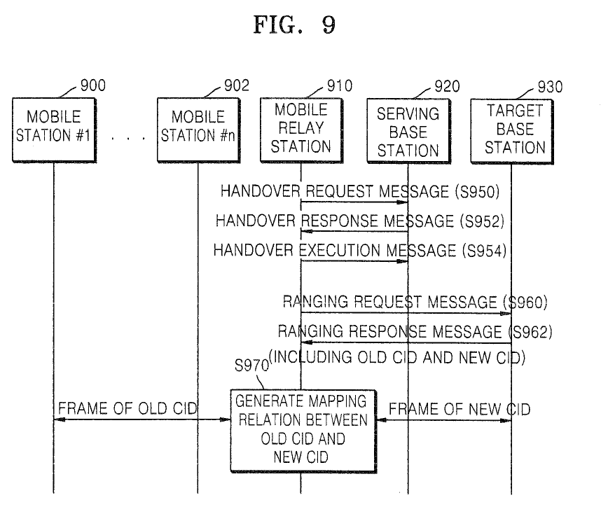

FIG. 9 illustrates an HO procedure by considering backward compatibility of MSs according to an embodiment of the present invention.

Referring to FIG. 9, when a handover is necessary, an MRS 910 transmits a handover request message including an ID of the MRS 910 to a serving BS 920 (S950). The ID may be a CID of an MAC header. The handover request message may be the existing message MOB_MSHO_REQ defined in IEEE 802.16e or a newly defined message.

The serving BS 920 transmits MAC addresses, service flow identifiers (SFIDs), CIDs, and the like of MSs 900 and 902 included a relay area of the MRS 910 to a target BS 930. The serving BS 920 receives HO_ID from the target BS 930 and transmits a handover response message including the HO_ID to the MRS 910 (S952). The handover response message may be the existing message MOB_BSHO_RSP defined in IEEE 802.16e or a newly defined message.

When receiving the handover response message, the MRS determines a target BS and transmits the handover execution message to the serving BS (S954). The handover execution message may be the existing message MOB_HO_IND defined in IEEE 802.16e or a newly defined message.

The MRS 910 performs a procedure of re-entering the network by transmitting a ranging request message including the HO_ID to the target BS (S960). When the MRS 910 shares a security association with the target BS 930, the MRS 910 transmits the ranging request message including HMAC/CMAC. When not receiving the HO_ID from the serving BS 920, the MRS 910 enables the target BS 930 to access the serving BS 920 through a backbone network and receive information on MAC addresses and CIDs of the MSs 900 and 902 by transmitting the ID of the serving BS 920 (BS ID) to the target BS 930.

New CIDs may be assigned to the MSs. In this case, the target BS 930 transmits a ranging response message including new CIDs which are newly assigned to the MSs 900 and 902 and old CIDs which are previous CIDs of the MSs 900 and 902 to the MRS 910 (S962). The ranging response message may be the existing message RNG_RSP defined in IEEE 802.16e or a newly defined message.

The MRS 910 generates a mapping relation between the new CIDs and the old to CIDs included in the ranging response message and changes CIDs of downlink frames toward the MSs and uplink frames toward the target BS to new CIDs based on the mapping relation.

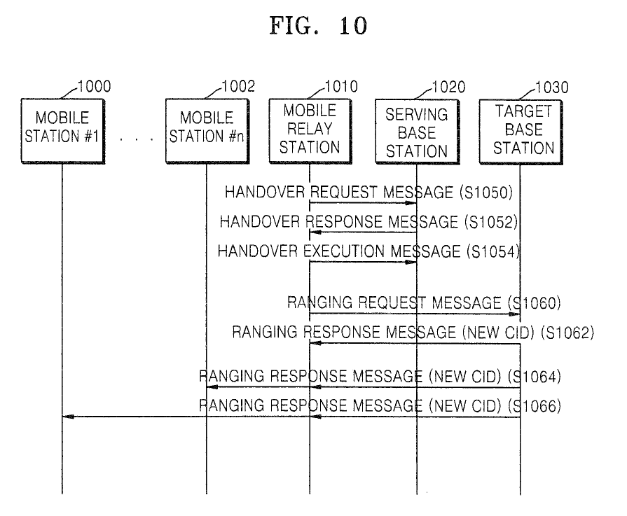

FIG. 10 illustrates an HO procedure by not considering backward compatibility of MSs according to an embodiment of the present invention.

Referring to FIG. 10, when a group handover procedure is performed only between an MRS 1010 and a serving BS and when the MRS 1010 amplifies and relays only signals of a target BS 1030 immediately after the MRS 1010 is connected to the target BS 1030, the MSs 1000 and 1002 recognizes that a BS is changed.

Since ranging parameters with the MRS need not be changed, when the MS determines that the BS is changed (that is, when a preamble is changed and when an ID of the BS transmitted from an MAP is changed), the MRS simply completes the HO procedure by relaying the message RNG_RSP transmitted from a new BS without a procedure of re-entering the network or HO procedure.

The procedures illustrated in FIG. 10 are the same as those illustrated in FIG. 9, except that the ranging response message including the changed CIDs of the MSs is provided to the MSs in addition to the MRS (S1062 to S1066).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A handover method for a Mobile Relay Station (MRS), the handover method comprising:
transmitting a handover request message to a serving Base Station (BS), wherein the handover request message includes an Identifier (ID) of the Mobile Relay Station; and
receiving a handover response message from the serving Base Station, wherein the handover response message indicates that the serving Base Station recognizes handover requests of the Mobile Relay Station and the Mobile Stations which are attached to the Mobile Relay Station.

2. The handover method of claim 1, wherein the Identifier of the Mobile Relay Station is a basic Communication Idendifier (CID) of a Media Access Control (MAC) header.

3. The handover method of claim 1, further comprising:
transmitting a handover execution message including information on a target Base Station to the serving Base Station; and
performing a handover ranging with the target Base Station.

4. A handover method for a Base Station (BS), the handover method comprising:
receiving a handover request message;
determining whether the handover request message is from a Mobile Relay Station (MRS) based on an Identifier (ID) included in the handover request message; and
transmitting a handover response message to the Mobile Relay Station, wherein the handover response message indicates that handover requests of the Mobile Relay Station and the Mobile Stations which are attached to the Mobile Relay Station are recognized.

5. The handover method of claim 4, wherein the Base Station stores an Identifier of the Mobile Relay Station and Identifiers of the Mobile Stations.

6. The handover method of claim 4, wherein the Identifier is a basic Communication Identifier (CID) of a Media Access Control (MAC) header.

7. The handover method of claim 4, further comprising:
receiving a handover execution message from the Mobile Relay Station, wherein the handover execution message includes information on a target Base Station;
performing handovers of the Mobile Stations; and
performing a handover ranging among the target Base Station and the Mobile Relay Station and the Mobile Stations.

8. A handover method in an Mobile Relay Station (MRS) environment, the handover method comprising:
transmitting a handover request message to a Base Station, wherein the handover request message includes an Identifier (ID) of the Mobile Relay Station and the transmitting is performed by the Mobile Relay Station;
transmitting a handover response message from the Base Station to the Mobile Relay Station, wherein the handover response message indicates that the Base Station recognizes handover requests of the Mobile Relay Station and the First Mobile Station;
transmitting a handover execution message to the Base Station, wherein the handover execution message includes information on a target Base Station; and
performing handovers of the Mobile Stations which are attached to the Mobile Relay Station.

9. A handover method in a Base Station (BS), the handover method comprising:
transmitting a handover request message to an Mobile Relay Station (MRS); and
receiving a handover execution message from the Mobile Relay Station, wherein the handover execution message includes information on a target Base Station.

10. The handover method of claim 9, wherein the Mobile Relay Station and Mobile Stations (MSs) perform a handover ranging with the target Base Station.

11. A handover method for a Mobile Relay Station (MRS), the handover method comprising:
transmitting a handover request message to a Base Station (BS), wherein the handover request message includes an Identifier (ID) of the Mobile Relay Station;
receiving a handover response message from the Base Station, wherein the handover response message indicates that the Base Station recognizes a handover request of the Mobile Relay Station;
transmitting a handover execution message to the Base Station, wherein the handover execution message includes information on a target Base Station;
transmitting a ranging request message to the target Base Station;
receiving a ranging response message from the target Base Station, wherein the ranging response message includes first Identifiers that are newly assigned to the Mobile Stations which are attached to the Mobile Relay Station; and
generating a mapping relation between second IDs that are previously assigned to the Mobile Stations and the first IDs that are newly assigned to the Mobile Stations.

12. The handover method of claim 11, wherein an ID of a frame received from the target BS is changed to a first ID, and an ID of a frame received from each MS is changed to a second ID.

13. The handover method of claim 11, wherein the first and second IDs are basic CIDs (communication identifiers) of MAC (media access control) headers.

14. The handover method of claim 11, wherein the Base Station transmits information on the First Mobile Stations to the target Base Station through a backbone network.

15. The handover method of claim 5, wherein the Identifier is a basic Communication Identifier (CID) of a Media Access Control (MAC) header.

16. The handover method of claim 12, wherein the first and second IDs are basic CIDs (communication identifiers) of MAC (media access control) headers.
